(19) United States
(12) Patent Application Publication
(10) Pub. No.: US 2025/0222412 A1
(43) Pub. Date: Jul. 10, 2025

(54) LIQUID OUTLET SYSTEM AND GAS-LIQUID MIXING DEVICE

(71) Applicant: SANITAR CO., LTD., NEW TAIPEI CITY (TW)

(72) Inventors: CHUN-HSIANG HSIAO, New Taipei City (TW); TIEN-YAO HUANG, NEW TAIPEI CITY (TW)

(21) Appl. No.: 18/614,722

(22) Filed: Mar. 24, 2024

(30) Foreign Application Priority Data
Jan. 10, 2024 (TW) 113100998

(51) Int. Cl. B01F 23/237; B01F 23/2326; B01F 35/21; B01F 35/221; E03C 1/084

(52) U.S. Cl. CPC B01F 23/237612; B01F 23/2326; B01F 23/23765; B01F 35/2115; B01F 35/2211; E03C 1/084

(57) ABSTRACT

A liquid delivery system and a gas-liquid mixing device are provided. The gas-liquid mixing device includes a ROS (reactive oxygen species) generation module, a RNS (reactive nitrogen species) generation module, a venturi, and a control module. The ROS generation module and the RNS generation module can react with air through electrical breakdown effect to respectively generate a plurality of ROS gas particles and a plurality of RNS gas particles. The venturi can generate a negative pressure to draw in the ROS gas particles and the RNS gas particles, so as to be mixed into a liquid. The control module can control one of the ROS generation module and the RNS generation module to perform electrical breakdown effect to obtain a surge duration, and another one of the ROS generation module and the RNS generation module to perform electrical breakdown effect after the surge duration.

### CROSS-REFERENCE TO RELATED PATENT APPLICATION

This application claims the benefit of priority to Taiwan Patent Application No. 113100998, filed on Jan. 10, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a liquid delivery system and a gas-liquid mixing device, and more particularly to a liquid delivery system and a gas-liquid mixing device that output liquid containing reactive oxygen species gas particles and reactive nitrogen species gas particles.

### BACKGROUND OF THE DISCLOSURE

To inhibit bacteria in the water, a conventional liquid delivery system outputs liquid mixed with ozone. However, since ozone is an unstable gas molecule, when ozone in the liquid comes into contact with the air, the ozone rapidly decomposes within a very short time, leading to insufficient duration for the liquid to possess antibacterial effects.

### SUMMARY OF THE DISCLOSURE

In response to the above-referenced technical inadequacy, the present disclosure provides a liquid delivery system and a gas-liquid mixing device.

In order to solve the above-mentioned problems, one of the technical aspects adopted by the present disclosure is to provide a liquid delivery system. The liquid delivery system includes a gas-liquid mixing device and a liquid outlet faucet. The gas-liquid mixing device includes a reactive oxygen species generation module, a venturi, and a control module. Air is configured to be input into the reactive oxygen species generation module and the reactive nitrogen species generation module, and the reactive oxygen species generation module and the reactive nitrogen species generation module are capable of reacting with the air through electrical breakdown effect to respectively generate a plurality of reactive oxygen species gas particles and a plurality of reactive nitrogen species gas particles. The venturi is communicated with the reactive oxygen species generation module and the reactive nitrogen species generation module. When a liquid passes through the venturi, the venturi is capable of generating a negative pressure to draw in the reactive oxygen species gas particles and the reactive nitrogen species gas particles, so that the reactive oxygen species gas particles and the reactive nitrogen species are mixed into the liquid to produce a target liquid. The control module is electrically coupled to the reactive oxygen species generation module and the reactive nitrogen species generation module. The control module is configured to control one of the reactive oxygen species generation module and the reactive nitrogen species generation module to perform electrical breakdown effect to obtain a surge duration in a relationship between voltage and time, and the control module is configured to control another one of the reactive oxygen species generation module and the reactive nitrogen species generation module to perform electrical breakdown effect after the surge duration. The liquid outlet faucet is connected to the venturi, and the liquid outlet faucet is configured to output the target liquid.

In order to solve the above-mentioned problems, another one of the technical aspects adopted by the present disclosure is to provide a gas-liquid mixing device. The gas-liquid mixing device includes a reactive oxygen species generation module, a venturi, and a control module. Air is configured to be input into the reactive oxygen species generation module and the reactive nitrogen species generation module, and the reactive oxygen species generation module and the reactive nitrogen species generation module are capable of reacting with the air through electrical breakdown effect to respectively generate a plurality of reactive oxygen species gas particles and a plurality of reactive nitrogen species gas particles. The venturi is communicated with the reactive oxygen species generation module and the reactive nitrogen species generation module. When a liquid passes through the venturi, the venturi is capable of generating a negative pressure to draw in the reactive oxygen species gas particles and the reactive nitrogen species gas particles, so that the reactive oxygen species gas particles and the reactive nitrogen species gas particles are mixed into the liquid to produce a target liquid. The control module is electrically coupled to the reactive oxygen species generation module and the reactive nitrogen species generation module. The control module is configured to control one of the reactive oxygen species generation module and the reactive nitrogen species generation module to perform electrical breakdown effect to obtain a surge duration in a relationship between voltage and time, and the control module is configured to control another one of the reactive oxygen species generation module and the reactive nitrogen species generation module to perform electrical breakdown effect after the surge duration.

Therefore, in the liquid delivery system and the gas-liquid mixing device provided by the present disclosure, by virtue of “air is configured to be input into the reactive oxygen species generation module and the reactive nitrogen species generation module, and the reactive oxygen species generation module and the reactive nitrogen species generation module reacting with the air through electrical breakdown effect to respectively generate a plurality of reactive oxygen species gas particles and a plurality of reactive nitrogen species gas particles,” “the reactive oxygen species gas particles and the reactive nitrogen species being mixed into the liquid to produce a target liquid,” and “the control module controlling one of the reactive oxygen species generation module and the reactive nitrogen species generation module to perform electrical breakdown effect to obtain a surge duration in a relationship between voltage and time, and another one of the reactive oxygen species generation module and the reactive nitrogen species generation module to perform electrical breakdown effect after the surge duration,” the liquid delivery system and the gas-liquid mixing device can extend the time that the liquid possesses antibacterial effects.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic partly planar view of a liquid delivery system according to the present disclosure;

FIG. 2 is a circuit block diagram of a gas-liquid mixing device according to the present disclosure;

FIG. 3 is a schematic partly planar view of the gas-liquid mixing device according to the present disclosure;

FIG. 4 is a schematic partly planar view of a reactive nitrogen species generation module according to the present disclosure;

FIG. 5 is a schematic partly planar view of a reactive oxygen species generation module according to the present disclosure;

FIG. 6 is a schematic cross-sectional view of a venturi according to the present disclosure; and

FIG. 7 is a graph illustrating a relationship between voltage and time for any one of the reactive oxygen species generation module and the reactive nitrogen species generation module of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In the following description, if it is indicated that “reference is made to a specific figure” or “as shown in a specific figure”, this is only to emphasize that in the description that follows, most content related thereto is depicted in said specific figure. However, the description that follows should not be construed as being limited to said specific figure only.

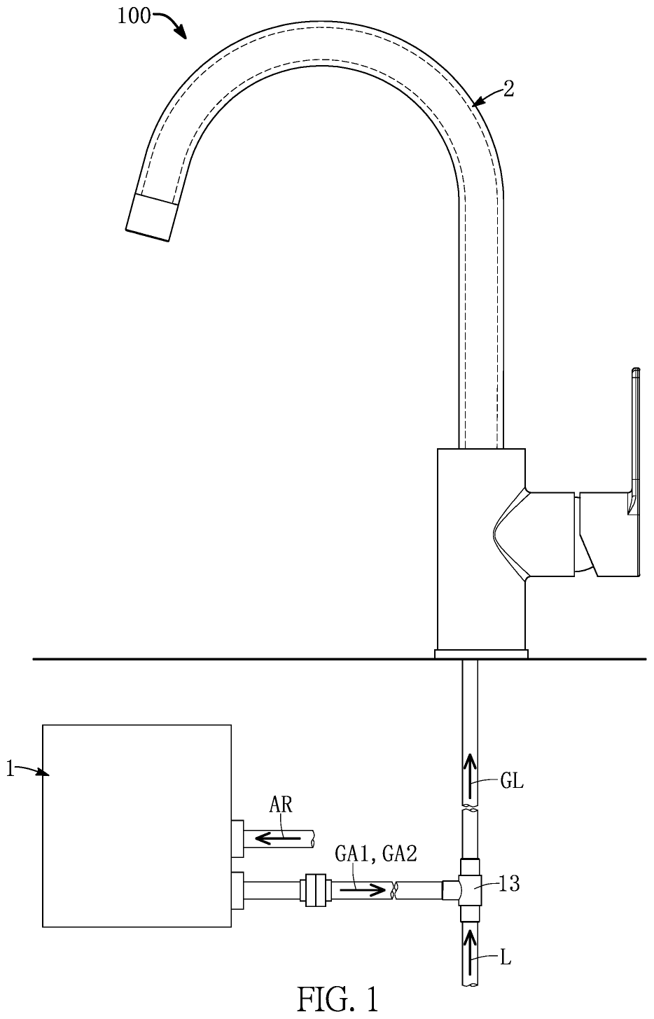

Referring to FIG. 1 to FIG. 7, the present disclosure provides a liquid delivery system 100. As shown in FIG. 1, the liquid delivery system 100 includes a gas-liquid mixing device 1 and a liquid outlet faucet 2 that is connected to the gas-liquid mixing device 1. The gas-liquid mixing device 1 can produce a plurality of reactive nitrogen species gas particles GA1 (e.g., nitrogen dioxide), and a plurality of reactive oxygen species gas particles GA2 (e.g., ozone). The gas-liquid mixing device 1 can mix the reactive nitrogen species gas particles GA1 and the reactive oxygen species gas particles GA2 into a liquid L (e.g., water) to produce a target liquid GL. The target liquid GL is provided to the user through the liquid outlet faucet 2.

When the reactive nitrogen species gas particles GA1 are mixed with the reactive oxygen species gas particles GA2, a RONS mixed gas can be formed to be added to the liquid L. ROS stands for reactive oxygen species, RNS stands for reactive nitrogen species, and RONS stands for reactive oxygen nitrogen species.

It should be noted that the gas-liquid mixing device 1 and the liquid outlet faucet 2 in the present embodiment are jointly defined as the liquid delivery system 100, but the present disclosure is not limited thereto. For example, the gas-liquid mixing device 1 can be independently used (e.g., implemented, manufactured, or sold) or can be used in cooperation with other components. The following description describes the structure and connection relationship of each component of the liquid delivery system 100.

Referring to FIG. 1 to FIG. 3, the gas-liquid mixing device 1 includes a RNS generation module 11, a ROS generation module 12, a venturi 13 connected to the RNS generation module 11 and the ROS generation module 12, and a control module 14 electrically coupled to the ROS generation module 12 and the RNS generation module 11.

Air AR can be input into the RNS generation module 11 and the ROS generation module 12, and the ROS generation module 12 and the RNS generation module 11 can react with the air AR through the electrical breakdown effect to respectively generate the ROS gas particles GA2 and the RNS gas particles GAL.

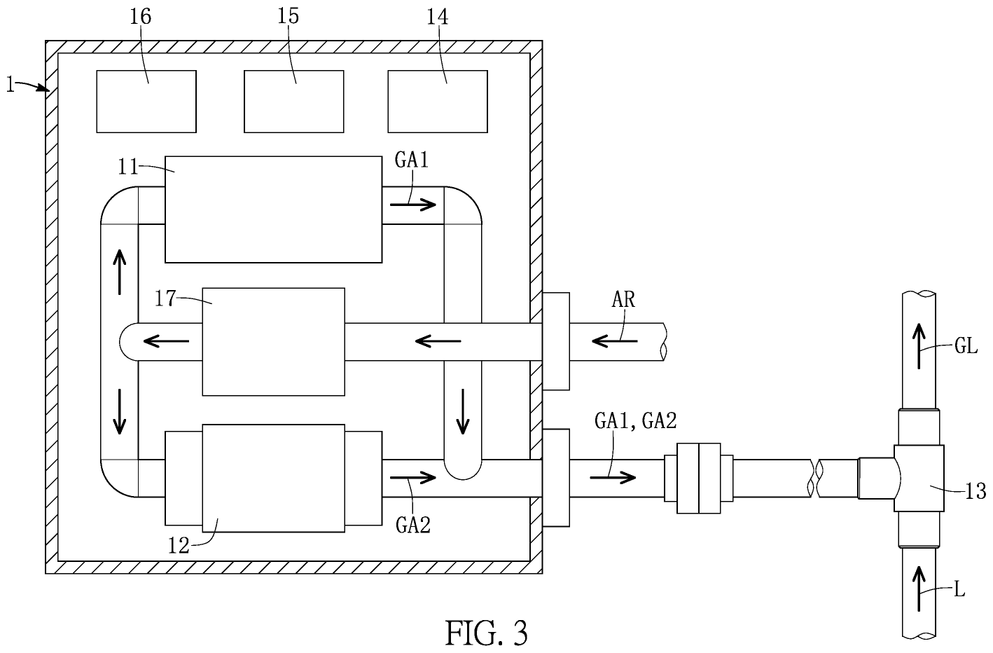

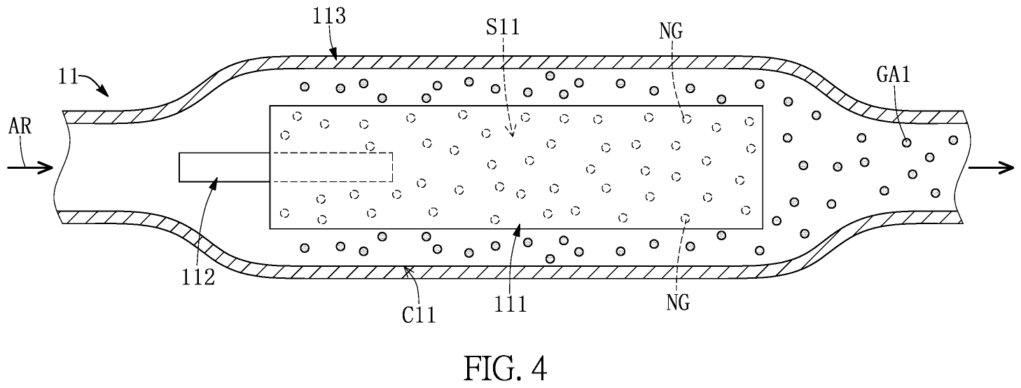

Referring to FIG. 3 and FIG. 4, in the present embodiment, the RNS generation module 11 can be used to generate ROS gas particles GA1 (e.g., nitrogen dioxide), and the RNS generation module 11 includes a dielectric capacitor 111, a high-voltage metal component 112, and a low-voltage metal component 113. Specifically, the dielectric capacitor 111 can be exemplified to be a cylindrical closed structure made of glass material, and the dielectric capacitor 111 has an enclosed space 11 that is filled with an inert gas NG. The high-voltage metal component 112 can be exemplified to be a metal rod, and the high-voltage metal component 112 penetrates the dielectric capacitor 111, so that one part of the high-voltage metal component 112 is located inside the enclosed space 11, and another part of the high-voltage metal component 112 is located outside the enclosed space 11. Accordingly, the another part of the high-voltage metal component 112 can be used to connect to the power source, and the one part of the high-voltage metal component 112 can block heat through the inert gas NG.

The low-voltage metal component 113 is disposed on one of two sides of the dielectric capacitor 111, and the low-voltage metal component 113 and the dielectric capacitor 111 are arranged to be spaced apart from each other, so that an RNS generation channel C11 is formed between the low-voltage metal component 113 and the dielectric capacitor 111. At least one part of the RNS generation channel C11 is located in a projection region defined by orthogonally projecting the high-voltage metal component 112 on the dielectric capacitor 111, so that the RNS generation channel C11 located in the projection region is configured to perform the electrical breakdown effect through the low-voltage metal component 113, the high-voltage metal component 112, and the dielectric capacitor 111. That is to say, when the air AR enters the RNS generation channel C11, the RNS generation channel C11 can transform the air through the electrical breakdown effect to generate the RNS gas particles GA1. A technique of utilizing dielectric breakdown effects on air with high voltage and low voltage in conjunction with dielectric materials is well-known in the art and is not the focus of the present disclosure. Therefore, details thereof will not be specifically described herein.

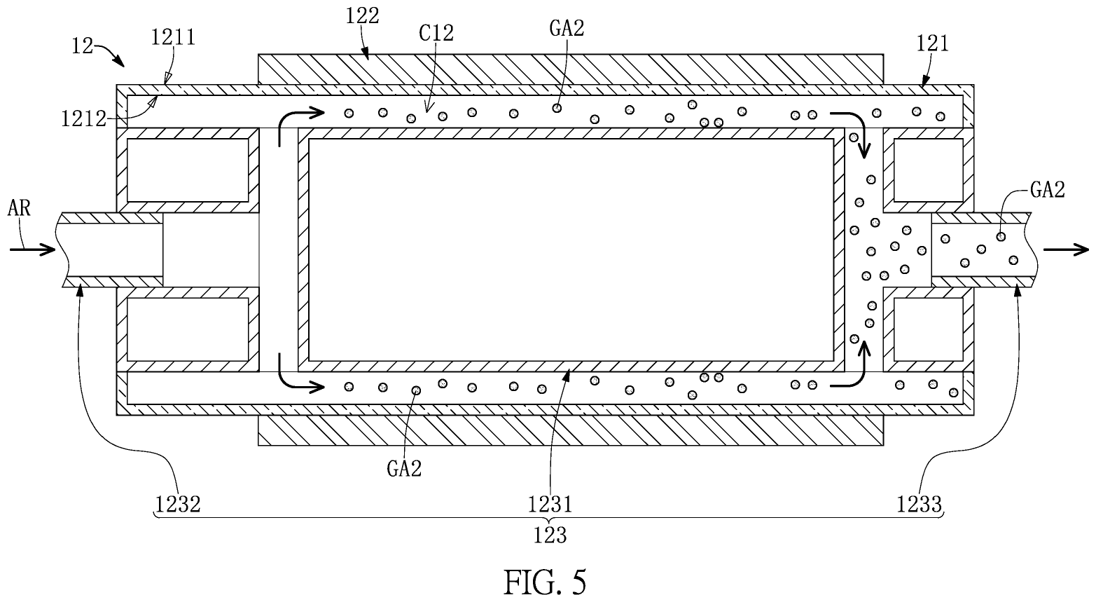

Referring to FIG. 3 and FIG. 5, in the present embodiment, the ROS generation module 12 can be used to generate the ROS gas particles GA2 (e.g., ozone), and the ROS generation module 12 includes a dielectric layer 121, a low-voltage metal layer 122, and a high-voltage metal body 123. Specifically, the dielectric layer 121 can be exemplified to be a tubular structure made of glass material, and the dielectric layer 121 includes a dielectric outer edge 1211 and a dielectric inner edge 1212. The low-voltage metal layer 122 can be exemplified to be a metal tube, and the dielectric outer edge 1211 is covered by the low-voltage metal layer 122.

Referring to FIG. 5, the high-voltage metal body 123 can be exemplified to be a container made of metal material, and the high-voltage metal body 123 is accommodated in the dielectric layer 121. In other words, the high-voltage metal body 123 is located in the dielectric inner edge 1212. The high-voltage metal body 123 includes an accommodation portion 1231, and an inflation portion 1232 and an exhaust portion 1233 that are connected to the accommodation portion 1231.

In detail, the accommodation portion 1231 has a high-voltage metal outer edge (not labeled). The high-voltage metal outer edge and the dielectric inner edge 1212 are spaced apart from each other, and a ROS generation channel C12 is formed between the high-voltage metal outer edge and the dielectric inner edge 1212. At least one part of the ROS generation channel C12 is located in a projection region defined by orthogonally projecting the low-voltage metal layer 122 on the dielectric inner edge 1212, so that the ROS generation channel C12 located in the projection region is configured to perform the electrical breakdown effect through the low-voltage metal layer 122, the high-voltage metal body 123, and the dielectric layer 121. A technique of utilizing dielectric breakdown effects on air with high voltage and low voltage in conjunction with dielectric materials is well-known in the art and is not the focus of the present disclosure. Therefore, details thereof will not be specifically described herein.

The inflation portion 1232 extends from one of two sides of the accommodation portion 1231, and the inflation portion 1232 is communicated with the ROS generation channel C12. The air AR can be input into the ROS generation channel C12 by the inflation portion 1232, so as to generate the ROS gas particles GA2.

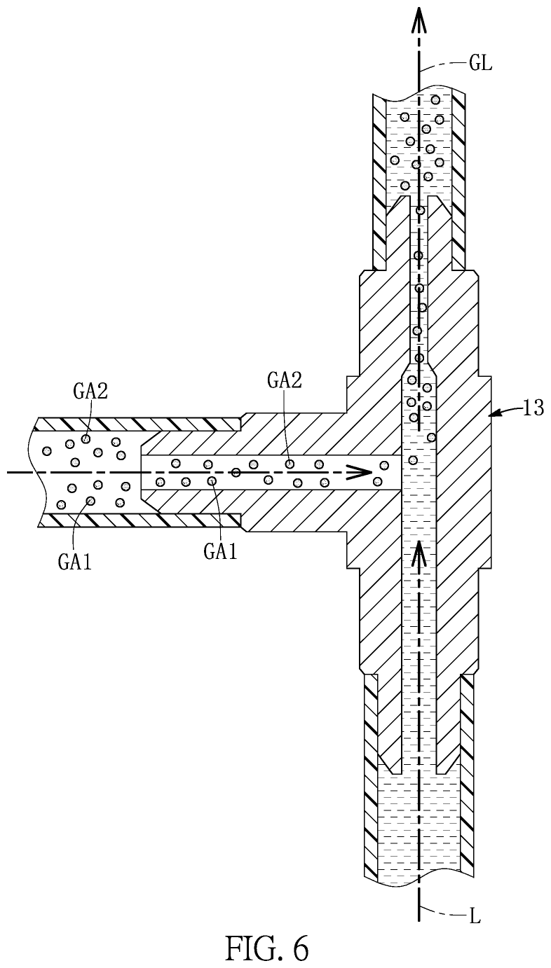

The exhaust portion extends from another one of the two sides of the accommodation portion 1231 (away from the inflation portion 1232), and the exhaust portion 1233 is communicated with the ROS generation channel C12. The exhaust portion 1233 can output the ROS gas particles GA2 from the ROS generation channel C12 into the venturi 13 through the negative pressure (as shown in FIG. 6).

It should be noted that the RNS generation module 11 and the ROS generation module 12 of the present disclosure can achieve a more desirable production efficiency compared to conventional ozone machines and nitrogen dioxide generators, but the present disclosure is not limited thereto. In practice, designers may also choose conventional components capable of generating ozone and nitrogen dioxide to replace the RNS generation module 11 and the ROS generation module 12 without considering production efficiency.

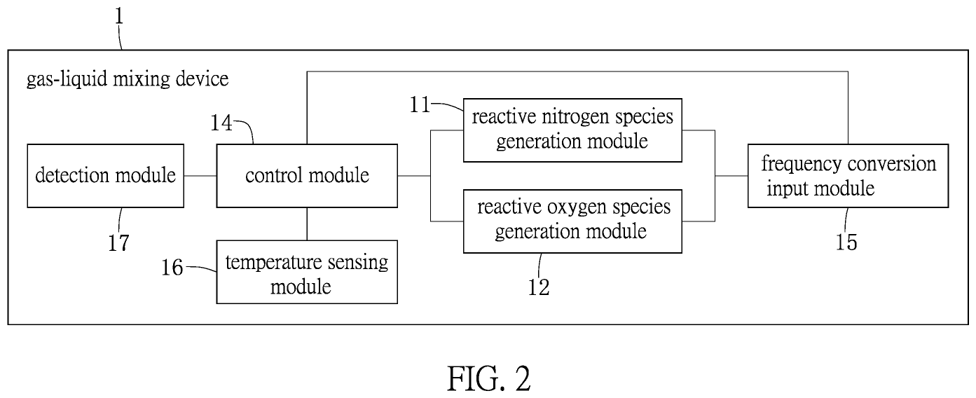

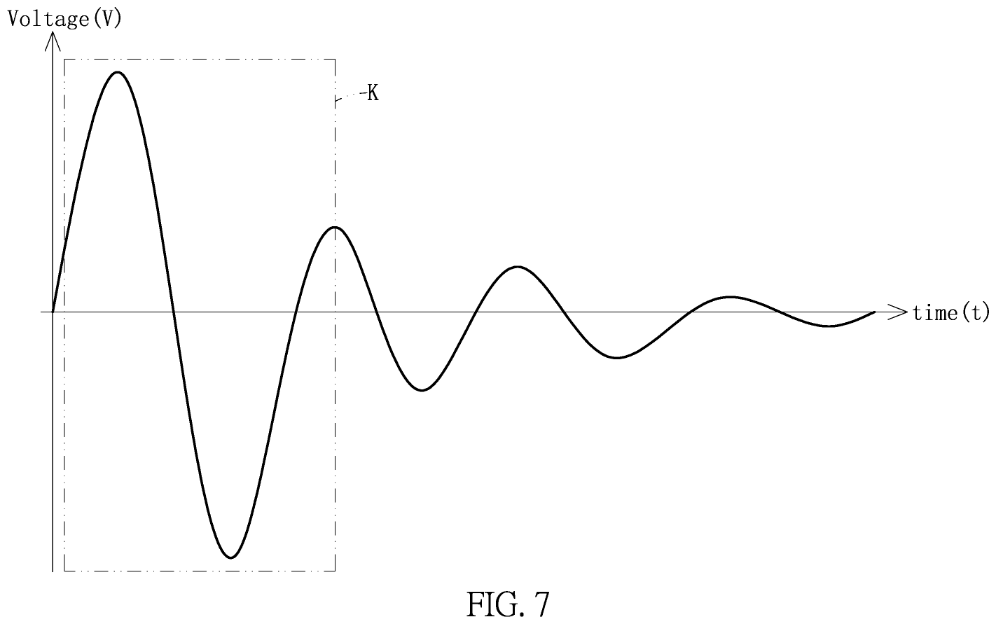

Referring to FIG. 1, FIG. 2, and FIG. 7, the control module 14 is electrically coupled to the RNS generation module 11 and the ROS generation module 12. The control module 14 can control one of the RNS generation module 11 and the ROS generation module 12 to perform the electrical breakdown effect to obtain a surge duration K in the relationship between voltage and time, and the control module 14 can control another one of the RNS generation module 11 and the ROS generation module 12 to perform the electrical breakdown effect after the surge duration K. Accordingly, the liquid delivery system 100 controls the RNS generation module 11 or the ROS generation module 12 through the control module 14 to perform delayed operation according to the surge duration K, so as to ensure that the noise generated by the RNS generation module 11 and the ROS generation module 12 does not interfere with each other, thereby avoiding a decrease in the production efficiency of the RNS gas particles GA1 and the ROS gas particles GA2.

For example, the control module 14 first controls the RNS generation module 11 to perform the electrical breakdown effect. When the RNS generation module 11 generates the RNS gas particles GA1, the control module 14 can obtain the voltage value (i.e., dv/dt) occurring within the RNS generation module 11 per unit time to detect the occurrence time of the peak value (i.e., the surge duration K). As an example, if the control module 14 detects that the surge duration K is 1000 milliseconds, the control module 14 will control the ROS generation module 12 to undergo the electrical breakdown effect after 1000 milliseconds, so that the ROS generation module 12 can work to generate the ROS gas particles GA2. In other words, before 1000 milliseconds, the RNS generation module 11 operates independently. After 1000 milliseconds, the RNS generation module 11 and the ROS generation module 12 work in sync.

It is worth noting that when the RNS generation module 11 and the ROS generation module 12 are operational, the heat generated by the RNS generation module 11 and the ROS generation module 12 can also suppress the production efficiency of the RNS gas particles GA1 and the ROS gas particles GA2. Therefore, the gas-liquid mixing device 1 may also include a frequency conversion input module 15 and a temperature sensing module 16.

Specifically, the frequency conversion input module 15 is electrically coupled to the control module 14, the RNS generation module 11, and the ROS generation module 12. The frequency conversion input module 15 can input an alternating current within a range from 10 kHz to 30 kHz to the RNS generation module 11 and the ROS generation module 12 to perform the electrical breakdown effect, respectively. The temperature sensing module 16 can sense the RNS generation module 11 and the ROS generation module 12 to respectively generate a temperature change data, and the temperature sensing module 16 transmits the temperature change data to the control module 14 for monitoring. When the temperature change data is increased, the control module 14 controls the frequency conversion input module 15 to increase the frequency of the alternating current. On the contrary, when the temperature change data is decreasing, the control module 14 controls the frequency conversion input module 15 to reduce the frequency of the alternating current, but the present disclosure is not limited thereto.

For example, in other embodiments of the present disclosure, the temperature sensing module 16 can be omitted. The control module 14 sets an operation time (e.g., five seconds) to increase or decrease the frequency of the alternating current. In other words, the control module 14 estimates the temperature change through the operation time.

Referring to FIG. 1, FIG. 2, and FIG. 6, the liquid outlet faucet 2 is connected to the venturi 13, and the liquid outlet faucet 2 can output the target liquid GL. That is to say, the liquid output from the liquid outlet faucet 2 contains the RNS gas particles GA1 and the ROS gas particles GA2.

In practice, when the liquid outlet faucet 2 is opened, the control module 14 will control the RNS generation module 11 and the ROS generation module 12 to perform the electrical breakdown effect. In detail, the gas-liquid mixing device 1 includes a detection module 17 electrically coupled to the control module 14. When the air AR passes through the detection module 17, the detection module 17 can send a working signal to the control module 14, so that the control module 14 controls the RNS generation module 11 to perform the electrical breakdown effect and obtains the surge duration K of the RNS generation module 11. The control module 14 controls the ROS generation module 12 to perform the electrical breakdown effect after the surge duration K.

### Beneficial Effects of the Embodiment

In conclusion, in the liquid delivery system and the gas-liquid mixing device provided by the present disclosure, by virtue of “air is configured to be input into the reactive oxygen species generation module and the reactive nitrogen species generation module, and the reactive oxygen species generation module and the reactive nitrogen species generation module reacting with the air through electrical breakdown effect to respectively generate a plurality of reactive oxygen species gas particles and a plurality of reactive nitrogen species gas particles,” “the reactive oxygen species gas particles and the reactive nitrogen species gas particles being mixed into the liquid to produce a target liquid,” and “the control module controlling one of the reactive oxygen species generation module and the reactive nitrogen species generation module to perform electrical breakdown effect to obtain a surge duration in a relationship between voltage and time, and another one of the reactive oxygen species generation module and the reactive nitrogen species generation module to perform electrical breakdown effect after the surge duration,” the liquid delivery system and the gas-liquid mixing device can extend the time that the liquid possesses antibacterial effects.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A liquid delivery system, comprising:
a gas-liquid mixing device including:
a reactive oxygen species generation module and a reactive nitrogen species generation module, wherein air is configured to be input into the reactive oxygen species generation module and the reactive nitrogen species generation module, and the reactive oxygen species generation module and the reactive nitrogen species generation module are capable of reacting with the air through electrical breakdown effect to respectively generate a plurality of reactive oxygen species gas particles and a plurality of reactive nitrogen species gas particles;
a venturi communicated with the reactive oxygen species generation module and the reactive nitrogen species generation module, wherein, when a liquid passes through the venturi, the venturi is capable of generating a negative pressure to draw in the reactive oxygen species gas particles and the reactive nitrogen species gas particles, so that the reactive oxygen species gas particles and the reactive nitrogen species gas particles are mixed into the liquid to produce a target liquid; and
a control module electrically coupled to the reactive oxygen species generation module and the reactive nitrogen species generation module, wherein the control module is configured to control one of the reactive oxygen species generation module and the reactive nitrogen species generation module to perform electrical breakdown effect to obtain a surge duration in a relationship between voltage and time, and the control module is configured to control another one of the reactive oxygen species generation module and the reactive nitrogen species generation module to perform electrical breakdown effect after the surge duration; and
a liquid outlet faucet connected to the venturi, wherein the liquid outlet faucet is configured to output the target liquid.

2. The liquid delivery system according to claim 1, wherein the gas-liquid mixing device includes a detection module electrically coupled to the control module; and wherein, when the air passes through the detection module, the detection module is configured to send a working signal to the control module, so that the control module controls the reactive oxygen species generation module to perform electrical breakdown effect and obtains the surge duration in the reactive oxygen species generation module, and the control module is configured to control the reactive nitrogen species generation module to perform electrical breakdown effect after the surge duration.

3. The liquid delivery system according to claim 1, wherein the gas-liquid mixing device includes a frequency conversion input module electrically coupled to the control module, the reactive oxygen species generation module, and the reactive nitrogen species generation module; and wherein the frequency conversion input module is configured to input an alternating current to the reactive oxygen species generation module and the reactive nitrogen species generation module to perform electrical breakdown effect, and a frequency of the alternating current is within a range from 10 kHz to 30 kHz.

4. The liquid delivery system according to claim 3, wherein the gas-liquid mixing device includes a temperature sensing module electrically coupled to the control module; wherein the temperature sensing module is configured to sense the reactive oxygen species generation module and the reactive nitrogen species generation module to respectively generate a temperature change data; wherein, when the temperature change data is increased, the control module controls the frequency conversion input module to increase the frequency of the alternating current; and wherein, when the temperature change data is reduced, the control module controls the frequency conversion input module to reduce the frequency of the alternating current.

5. The liquid delivery system according to claim 1, wherein the reactive oxygen species generation module includes:
a dielectric layer including a dielectric outer edge and a dielectric inner edge;
a low-voltage metal layer, wherein the dielectric outer edge is covered by the low-voltage metal layer; and
a high-voltage metal body disposed in the dielectric inner edge, and including:
an accommodation portion having a high-voltage metal outer edge and a high-voltage metal inner edge, and a reactive oxygen species generation channel is formed between the high-voltage metal outer edge and the dielectric inner edge, wherein at least one part of the reactive oxygen species generation channel is located in a projection region defined by orthogonally projecting the low-voltage metal layer on the dielectric inner edge, so that the reactive oxygen species generation channel located in the projection region is configured to perform electrical breakdown effect through the low-voltage metal layer, the high-voltage metal body, and the dielectric layer;
an inflation portion disposed on one of two sides of the accommodation portion, wherein the inflation portion is communicated with the reactive oxygen species generation channel, and the air is configured to be input into the reactive oxygen species generation channel by the inflation portion, so as to generate the reactive oxygen species gas particles; and
an exhaust portion disposed on another one of the two sides of the accommodation portion, wherein the exhaust portion is communicated with the reactive oxygen species generation channel, and the exhaust portion is configured to output the reactive oxygen species gas particles from the reactive oxygen species generation channel to the venturi through the negative pressure.

6. The liquid delivery system according to claim 1, wherein the reactive nitrogen species generation module includes:
a dielectric capacitor including an enclosed space having an inert gas;
a high-voltage metal component partially disposed in the enclosed space;
a low-voltage metal component disposed on one of two sides of the dielectric capacitor, wherein a reactive nitrogen species generation channel is formed between the low-voltage metal component and the dielectric capacitor, and at least one part of the reactive nitrogen species generation channel is located in a projection region defined by orthogonally projecting the high-voltage metal component on the dielectric capacitor, so that the reactive nitrogen species generation channel located in the projection region is configured to perform electrical breakdown effect through the low-voltage metal component, the high-voltage metal component, and the dielectric capacitor, and wherein the air is configured to be input into the reactive nitrogen species generation channel to perform electrical breakdown effect, so as to generate the reactive nitrogen species gas particles, and the venturi is capable of drawing in the reactive nitrogen species gas particles through the negative pressure.

7. A gas-liquid mixing device, comprising:
a reactive oxygen species generation module and a reactive nitrogen species generation module, wherein air is configured to be input into the reactive oxygen species generation module and the reactive nitrogen species generation module, and the reactive oxygen species generation module and the reactive nitrogen species generation module are capable of reacting with the air through electrical breakdown effect to respectively generate a plurality of reactive oxygen species gas particles and a plurality of reactive nitrogen species gas particles;
a venturi communicated with the reactive oxygen species generation module and the reactive nitrogen species generation module, wherein, when a liquid passes through the venturi, the venturi is capable of generating a negative pressure to draw in the reactive oxygen species gas particles and the reactive nitrogen species gas particles, so that the reactive oxygen species gas particles and the reactive nitrogen species gas particles are mixed into the liquid to produce a target liquid; and
a control module electrically coupled to the reactive oxygen species generation module and the reactive nitrogen species generation module, wherein the control module is configured to control one of the reactive oxygen species generation module and the reactive nitrogen species generation module to perform electrical breakdown effect to obtain a surge duration in a relationship between voltage and time, and the control module is configured to control another one of the reactive oxygen species generation module and the reactive nitrogen species generation module to perform electrical breakdown effect after the surge duration.

8. The gas-liquid mixing device according to claim 7, further comprising:
a frequency conversion input module electrically coupled to the control module, the reactive oxygen species generation module, and the reactive nitrogen species generation module, wherein the frequency conversion input module is configured to input an alternating current to the reactive oxygen species generation module and the reactive nitrogen species generation module to perform electrical breakdown effect, and a frequency of the alternating current is within a range from 10 kHz to 30 kHz; and
a temperature sensing module electrically coupled to the control module, wherein the temperature sensing module is configured to sense the reactive oxygen species generation module and the reactive nitrogen species generation module to respectively generate a temperature change data, wherein, when the temperature change data is increased, the control module controls the frequency conversion input module to increase the frequency of the alternating current, and wherein, when the temperature change data is reduced, the control module controls the frequency conversion input module to reduce the frequency of the alternating current.

9. The gas-liquid mixing device according to claim 7, wherein the reactive oxygen species generation module includes:
a dielectric layer including a dielectric outer edge and a dielectric inner edge;
a low-voltage metal layer, wherein the dielectric outer edge is covered by the low-voltage metal layer; and
a high-voltage metal body disposed in the dielectric inner edge, and including:
an accommodation portion having a high-voltage metal outer edge and a high-voltage metal inner edge, and a reactive oxygen species generation channel is formed between the high-voltage metal outer edge and the dielectric inner edge, wherein at least one part of the reactive oxygen species generation channel is located in a projection region defined by orthogonally projecting the low-voltage metal layer on the dielectric inner edge, so that the reactive oxygen species generation channel located in the projection region is configured to perform electrical breakdown effect through the low-voltage metal layer, the high-voltage metal body, and the dielectric layer;
an inflation portion disposed on one of two sides of the accommodation portion, wherein the inflation portion is communicated with the reactive oxygen species generation channel, and the air is configured to be input into the reactive oxygen species generation channel by the inflation portion, so as to generate the reactive oxygen species gas particles; and
an exhaust portion disposed on another one of the two sides of the accommodation portion, wherein the exhaust portion is communicated with the reactive oxygen species generation channel, and the exhaust portion is configured to output the reactive oxygen species gas particles from the reactive oxygen species generation channel to the venturi through the negative pressure.

10. The gas-liquid mixing device according to claim 7, wherein the reactive nitrogen species generation module includes:
a dielectric capacitor including an enclosed space having an inert gas;
a high-voltage metal component partially disposed in the enclosed space; and
a low-voltage metal component disposed on one of two sides of the dielectric capacitor, wherein a reactive nitrogen species generation channel is formed between the low-voltage metal component and the dielectric capacitor, and at least one part of the reactive nitrogen species generation channel is located in a projection region defined by orthogonally projecting the high-voltage metal component on the dielectric capacitor, so that the reactive nitrogen species generation channel located in the projection region is configured to perform electrical breakdown effect through the low-voltage metal component, the high-voltage metal component, and the dielectric capacitor, and wherein the air is configured to be input into the reactive nitrogen species generation channel to perform electrical breakdown effect, so as to generate the reactive nitrogen species gas particles, and the venturi is capable of drawing in the reactive nitrogen species gas particles through the negative pressure.
